(19) United States
(12) Patent Application Publication
(10) Pub. No.: US 2025/0307082 A1
(43) Pub. Date: Oct. 2, 2025

(54) BACKUP MANAGEMENT OF OPERATION LOGS FOR NON-RELATIONAL DATABASES

(71) Applicant: Rubrik, Inc., Palo Alto, CA (US)

(72) Inventors: Abhishek Srivastava, Bangalore (IN); Bittu Kumar, Bangalore (IN); Deepak Verma, Bangalore (IN); Rahul Thapliyal, Bangalore (IN)

(21) Appl. No.: 18/620,729

(22) Filed: Mar. 28, 2024

(51) Int. Cl. G06F 11/14

(52) U.S. Cl. CPC G06F 11/1458; G06F 2201/80

(57) ABSTRACT

Methods, systems, and devices for data management are described. For example, techniques for scalable backup solutions for non-relational databases are described. Operation logs (oplogs) may capture changes that occur at a non-relational database. A data management system (DMS) may use multiple queues and local disk memory of the host of the non-relational database to streamline the movement of oplogs from the non-relational database to a remote storage environment accessible to the DMS. Oplogs may be parsed into a multitenant queue, moved from the multitenant queue to collection-specific queues, written from the collection-specific queues to local disk memory of the host, and moved from the local disk memory of the host to the remote storage environment. Oplogs from multiple collections may be moved from the collection-specific queues to local disk memory of the host and from the local disk memory to the remote storage environment in parallel, reducing latency.

### FIELD OF TECHNOLOGY

The present disclosure relates generally to data management, including techniques for backup management of operation logs for non-relational databases.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports backup management of operation logs for non-relational databases in accordance with aspects of the present disclosure.

FIG. 2 shows an example of a non-relational database cluster that supports backup management of operation logs for non-relational databases in accordance with aspects of the present disclosure.

FIG. 3 shows an example of an operation log (oplog) backup process diagram that supports backup management of operation logs for non-relational databases in accordance with aspects of the present disclosure.

FIG. 4 shows an example of an oplog backup process that supports backup management of operation logs for non-relational databases in accordance with aspects of the present disclosure.

FIG. 5 shows an example of a process flow that supports backup management of operation logs for non-relational databases in accordance with aspects of the present disclosure.

FIG. 6 shows a block diagram of an apparatus that supports backup management of operation logs for non-relational databases in accordance with aspects of the present disclosure.

FIG. 7 shows a block diagram of a DMS Manager that supports backup management of operation logs for non-relational databases in accordance with aspects of the present disclosure.

FIG. 8 shows a diagram of a system including a device that supports backup management of operation logs for non-relational databases in accordance with aspects of the present disclosure.

FIGS. 9 through 11 show flowcharts illustrating methods that support backup management of operation logs for non-relational databases in accordance with aspects of the present disclosure.

### DETAILED DESCRIPTION

A data management system (DMS) may include various nodes, clusters, and sub-systems that provide backup and recovery services for customer computing systems or databases. Backup processes may involve capturing snapshots of customer computing systems or databases and storing the snapshots at a storage environment accessible to the DMS. In some cases, the DMS may provide backup and/or recovery services for a non-relational database. For example, a non-relational database may not use a tabular schema of rows and columns and/or may be referred to as a non-SQL or noSQL database. For example, a Mongo database may be a non-relational database. In some examples, a non-relational database may be a document-oriented database that utilizes JSON-like documents and may include multiple (e.g., thousands of) collections of documents. A non-relational database may be stored at multiple hosts (e.g., a primary host and one or more secondary hosts) which each store a full copy of the data in the database. For example, changes at the primary host may periodically be updated to be reflected at the secondary hosts.

Operation logs (which may alternatively be referred to as oplogs) may capture changes that occur at a given collection at a primary host which may then be replicated to the secondary hosts. For example, an operation log may indicate modifications to documents, deletions of documents, and/or additions of documents within a collection. Oplogs may be stored in an oplog collection within the non-relational database. The DMS may capture periodic snapshots of a non-relational database and store the snapshots in a remote storage environment. As the snapshots are periodic, however, some changes to the non-relational database which occurred between snapshots may not be reflected in the snapshots. Additionally, snapshots may be captured from the multiple hosts in parallel. Oplogs may be used by the DMS to ensure consistency between backup data captured from the multiple hosts. Further, oplogs may be used with periodic snapshots to determine the state of a document at any point in time. As there may be thousands of collections per non-relational database, however, backing up oplogs for a non-relational database to a remote storage environment and associating each oplog with the corresponding collection may not be scalable for customers of a DMS (e.g., may involve undesirable latencies, among other potential drawbacks).

Aspects of this disclosure relate to techniques for scalable backup solutions for non-relational databases. To streamline the movement of oplogs from the non-relational database to a remote storage environment, multiple queues and local disk memory of the host may be used. For example, a parser thread (e.g., also referred to as a parser) may read oplog files as they are generated by the host into a multitenant queue in working memory of the non-relational database host that is common to all collections of the non-relational database. As the parser thread may read the oplogs from the working memory of the non-relational database host into the multitenant queue before the operation logs are written into disk memory of the host, the parser thread may avoid the latency associated with disk input/output operations. Additionally, the oplog collection may have a fixed size, and thus reading the oplogs into the multitenant queue may avoid potential loss of data due to rollover of the oplog collection. Local writer threads at the host may organize the operation logs in the multitenant queue into collection-specific queues in the working memory of the host. The local writer threads may write the operation logs from the collection-specific queues into local disk memory of the host and may orchestrate remote writer threads to transfer the operation logs from the local disk memory to the remote storage environment. The remote writer threads may move the oplogs from the local disk memory to the remote storage environment in parallel, thereby decreasing latency. Additionally, as the oplog may be transferred from the local disk memory to the remote storage environment, the operation logs may be transferred at a rate that is based on and does not overwhelm the network connection between the host and the remote storage environment.

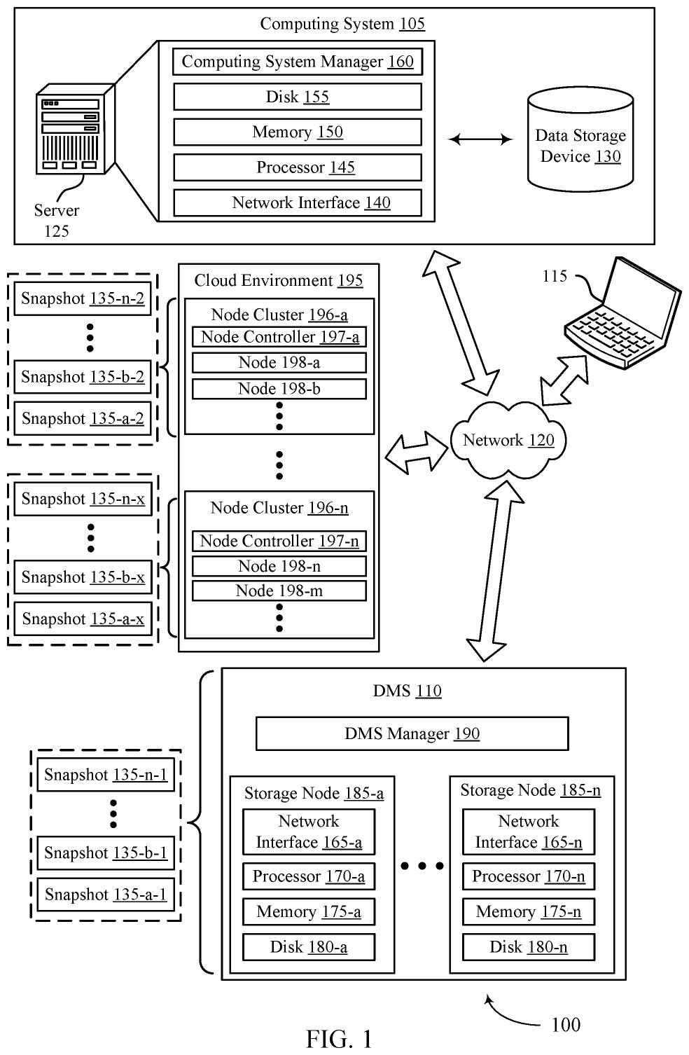

FIG. 1 illustrates an example of a computing environment 100 that supports backup management of operation logs for non-relational databases in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state-which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

The DMS 110 may provide backup and recovery services for a non-relational database. For example, the computing system 105 may be a non-relational database and the DMS 110 may capture snapshots 135 of the non-relational database. The non-relational database may be stored at multiple hosts (e.g., a primary host and one or more secondary hosts) which each store a full copy of the data in the database. For example, different hosts may be different servers, different virtual machines, or different storage nodes. Data in the non-relational database may be organized as collections of documents (e.g., JSON-like documents). Oplogs may capture changes that occur at a given collection at a primary host which may then be replicated to the secondary hosts. For example, an operation log may indicate modifications to documents, deletions of documents, and/or additions of documents within a collection. Oplogs may be stored in an oplog collection within the non-relational database.

The DMS 110 may capture periodic snapshots of a non-relational database and store the snapshots in a remote storage environment (e.g., one or more storage nodes 185 at the DMS 110 or one or more node clusters 196 at the cloud environment 195). For example, the DMS 110 (e.g., an agent of the DMS at the host of the non-relational database) may establish a cursor on a given collection and may extract documents in the collection, which may be the actual data stored for the given collection. The documents may then be stored in the remote storage environment. As the snapshots are periodic, however, some changes to the non-relational database which occurred between snapshots may not be reflected in the snapshots. Additionally, snapshots may be captured from the multiple hosts in parallel. Oplogs may be used by the DMS 110 to ensure consistency between backup data captured from the multiple hosts. Further, oplogs may be used with periodic snapshots to determine the state of a document at any point in time. As there may be thousands of collections per non-relational database, however, backing up oplogs for a non-relational database to a remote storage environment and associating each oplog with the corresponding collection may not be scalable for customers of the DMS 110 (e.g., may involve undesirable latencies, among other potential drawbacks).

The DMS 110 may implement techniques for scalable backup solutions for non-relational databases. To streamline the movement of oplogs from the non-relational database to a remote storage environment, multiple queues and local disk memory of the host may be used. For example, a parser thread may read oplog files as they are generated by the host into a multitenant queue in working memory of the non-relational database host that is common to all collections of the non-relational database. As the parser thread reads the oplogs from the working memory of the non-relational database host into the multitenant queue before the operation logs are written into disk memory of the host (, the parser thread avoids the latency associated with disk input/output operations. Additionally, the oplog collection may have a fixed size, and thus reading the oplogs into the multitenant queue avoids potential loss of data. Local writer threads at the host may organize the operation logs in the multitenant queue into collection-specific queues in the working memory of the host. The local writer threads may write the operation logs from the collection-specific queues into local disk memory of the host and may orchestrate remote writer threads to transfer the operation logs from the local disk memory to the remote storage environment. The remote writer threads may move the oplogs from the local disk memory to the remote storage environment in parallel, thereby decreasing latency. Additionally, as the oplog may be transferred from the local disk memory to the remote storage environment, the operation logs may be transferred at a rate that is based on and does not overwhelm the network connection between the host and the remote storage environment.

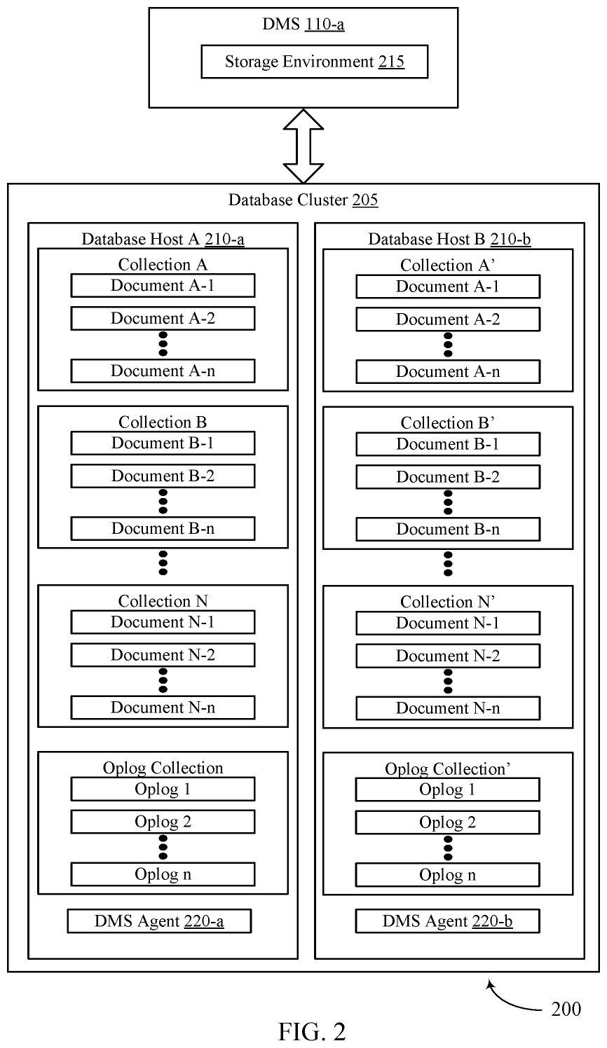

FIG. 2 shows an example of a diagram 200 of a non-relational database cluster 205 that supports backup management of operation logs for non-relational databases in accordance with aspects of the present disclosure. The diagram 200 may implement or may be implemented by one or more aspects of the computing environment 100. For example, a DMS 110-a may back up (e.g., may capture snapshots of) data stored at the non-relational database cluster 205. The DMS 110-a may be an example of a DMS 110 as described herein.

The non-relational database cluster 205 may include multiple non-relational database hosts 210 that include copies of the same data (e.g., include synchronized copies of a non-relational database). For example, the non-relational database cluster 205 may include a non-relational database host A 210-a and a non-relational database host B 210-b. The non-relational database host A 210-a may store a first copy of the non-relational database and the non-relational database host B 210-b may store a second copy of the non-relational database. To maintain copies of the same data (e.g., the non-relational database), data may be replicated from the non-relational database host A 210-a to the non-relational database host B 210-b (e.g., the non-relational database host A 210-a may be a primary host and the non-relational database host B 210-b may be a secondary host). In some examples, the non-relational database host A 210-a and the non-relational database host B 210-b may host a Mongo database. For example, collection-specific oplogs may capture changes that occur at a given collection in the non-relational database host A 210-a. Based on the oplogs, the changes may be copied to the non-relational database host B 210-b. Oplogs may be stored in an oplog collection (e.g., an oplog.rs collection at the non-relational database host A 210-a and the non-relational database host B 210-b).

The non-relational database host A 210-a and non-relational database host B 210-b may store collections of data including one or more documents. For example, the non-relational database host A 210-a may store a collection A which includes documents A-1 through A-n, a collection B which includes documents B-1 through B-n, and a collection N which includes documents N-1 through N-n. The non-relational database host B 210-b may store a copy of the data stored at the non-relational database host A 210-a, and accordingly the non-relational database host B 210-b may store a collection A′ which includes documents A-1 through A-n (e.g., the collection A′ may be a copy of the collection A), a collection B′ which includes documents B-1 through B-n (e.g., the collection B′ may be a copy of the collection B), and a collection N′ which includes documents N-1 through N-n (e.g., the collection N′ may be a copy of the collection N). In some examples, a document in a non-relational database may be a key value pair list or array or a nested document. In some examples, a non-relational database may store data records as binary JSON (BSON) documents (e.g., a BSON may be a binary representation of a JSON document).

In some examples, a DMS 110-a may manage backup operations for the non-relational database. For example, the DMS 110-a may set up a cursor at the different collections and may extract documents from the different collections and store the extracted documents in a remote storage environment 215 (e.g., one or more storage nodes 185 at the DMS 110 or one or more node clusters 196 at the cloud environment 195). In some examples, an agent 220 of the DMS 110-a may manage backup operations at a given database host (e.g., the agent 220-a may manage backup operations for the non-relational database host A 210-a and the agent 220-b may manage backup operations for the non-relational database host B 210-b).

In some examples, the DMS 110-a may capture backups of collections from the multiple non-relational database hosts 210 in parallel. For example, the DMS 110-a may capture documents from a first set of collections from the non-relational database host A 210-a and the DMS 110-a may capture documents from a second set of collections from the non-relational database host B 210-b. In some examples, the DMS 110 may also capture oplogs. For example, the DMS 110 may set up a cursor that tails the oplog collection (e.g., the oplog.rs collection). In some examples, the oplogs may be collected and stored in the remote storage environment periodically. As the oplog collection may include the oplogs for all the collections in the non-relational database (e.g., collection A through collection N), and there may be thousands of collections per non-relational database, the DMS 110 may implement scalable, fault-tolerant, and backup-consistent solutions for capturing and storing backups of oplogs.

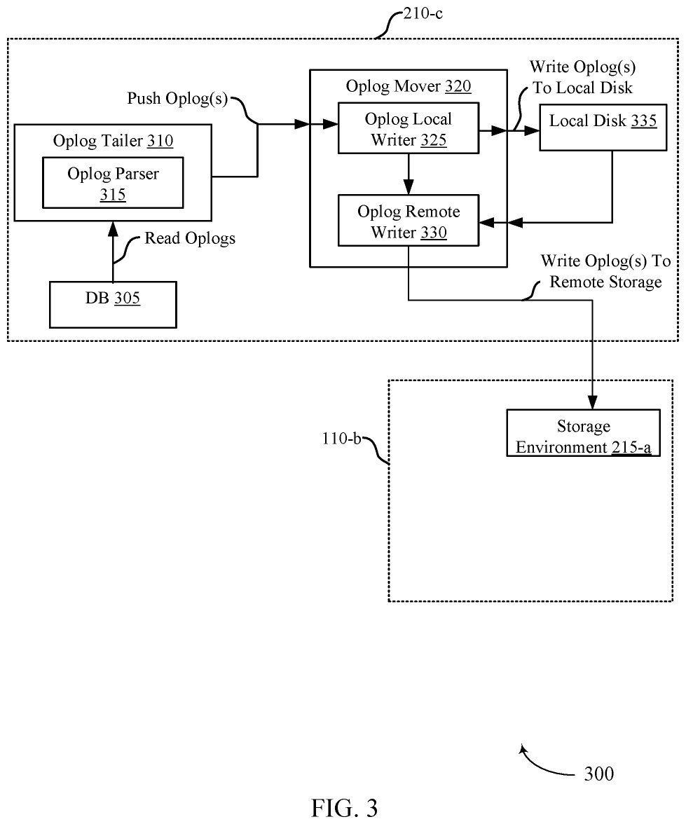

In some examples, the agent 220-a of the DMS 110-a at the non-relational database host A 210-a may insert a marker document into a designated collection (e.g., collection B may be the designated collection). For example, during initialization of the non-relational database, the designated collection for marker documents may be created. The designated collection for marker documents may serve as a marker to indicate that a snapshot is going to be taken of the non-relational database. Snapshots may be performed at the database level, meaning each collection in the non-relational database may be included in a snapshot. When the marker document is added to the designated collection for marker document, an oplog indicating the addition of the marker document to the designated collection (e.g., collection B) may be added to the oplog collection. When the agent 220-a detects that an oplog for collection B indicates the insertion of the marker document, the agent 220-a may determine that the non-relational database host A 210-a is synchronized with the non-relational database host B 210-b (e.g., changes in the non-relational database host A 210-a have been copied to the non-relational database host B 210-b), and accordingly parallel backups may be performed on the non-relational database host A 210-a and the non-relational database host B 210-b. Accordingly, in some examples, the agents 220 may initiate backup operations in response to detection of the marker document in the oplog collection. For example, when a parser thread, as described with reference to FIG. 3 encounters an oplog for the designated marker document collection, the parser thread may determine that a snapshot is about to be taken of the non-relational database (e.g., for all collections). In some examples, marker documents may be periodically inserted to the specified collection at a given frequency.

FIG. 3 shows an example of an oplog backup process diagram 300 that supports backup management of operation logs for non-relational databases in accordance with aspects of the present disclosure. The oplog backup process diagram 300 may implement or may be implemented by one or more aspects of the computing environment 100 or the diagram 200. For example, the oplog backup process diagram 300 includes a DMS 110-b which may be an example of the DMS 110 as described herein. The oplog backup process diagram 300 includes a non-relational database host 210-c, which may be an example of a non-relational database host 210 as described herein. The oplog backup process diagram 300 includes a remote storage environment 215-a, which may be an example of a remote storage environment 215 as described herein.

The DMS 110-b may provide backup and recovery services for the non-relational database 305, which may include multiple collections of documents, and may be hosted at the non-relational database host 210-c. For example, an agent 220 of the DMS 110-b may extract data from one or more collections at the non-relational database 305 and move the data (e.g., copy the data) to the remote storage environment 215-a. In some examples, the DMS 110-b may extract and store oplogs from the non-relational database 305, where the oplogs may indicate changes in collections of the non-relational database 305 and may be stored in an oplog collection (e.g., an oplog.rs collection in the non-relational database 305).

A dedicated thread at the non-relational database host 210-c (e.g., the oplog tailer 310) may tail the oplog.rs collection in the non-relational database host 210-c and may include an oplog parser 315 which may read oplogs that are added to the oplog collection (e.g., from the oplog.rs collection). Reading the oplogs as the oplogs are added to the oplog collection (e.g., the oplog.rs collection) may ensure real-time processing and capturing of oplog data (e.g., and thus real-time processing and capturing of changes occurring in collections of the non-relational database host 210-c). In some examples, the oplog parser 315 may read the oplogs from the oplog collection in working memory of the non-relational database host 210-c (e.g., instead of disk memory of the non-relational database host 210-c to avoid disk I/O). The speed at which the oplog parser 315 may read the oplogs from the oplog collection may be controlled by the non-relational database host 210-c. In some examples, the oplog parser 315 may read oplogs from the oplog collection in disk memory of the non-relational database host 210-c, for example, if the oplog parser 315 falls behind reading the oplogs from the oplog collection in working memory. The oplog parser 315 may parse and filter the oplogs based on parsing/filtering criteria (e.g., which collection the oplog is associated with, how many changes are reflected in the oplog, a data size of the oplog, a total data size reflected by the oplog, or a combination thereof). The oplog tailer 310 may push the parsed and filtered oplogs to an oplog local writer 325 of the non-relational database. In some examples, the oplog local writer 325 may be a sub-thread of an oplog mover 320 (e.g., an oplog mover thread). In some examples, the oplog mover 320 may include an oplog remote writer 330 (e.g., which may be a sub-thread of the oplog mover thread).

The oplog local writer 325 may operate as an orchestrator thread that consumes oplogs from the oplog tailer 310 and writes the consumed oplogs to a local disk 335 of the non-relational database host 210-c. The orchestrator thread (e.g., the oplog local writer 325) may create a set of internal local writer threads, each responsible for writing oplog data to a local disk 335 of the non-relational database host 210-c. In some examples, once a given internal local writer thread writes data to the local disk 335, the given internal local writer thread may submit a request to the oplog remote writer 330 to move the written data to the remote storage environment 215-a. Operation of the oplog local writer 325 as an orchestrator thread may ensure a streamlined flow of oplog data. The orchestrator thread may coordinate the consumption of oplogs and may delegate the task of writing oplogs to the local disk 335 to the internal local writer threads, which may efficiently write data in oplogs to the local disk 335 of the non-relational database host 210-c. Once data of an oplog is written to the local disk 335 of the non-relational database host 210-c, a corresponding request to move the written data to the remote storage environment 215-a may be passed to the oplog remote writer 330, which may manage the movement of data from the local disk 335 to the remote storage environment 215-a.

The oplog remote writer 330 may facilitate movement of oplog data from the local disk 335 to the remote storage environment 215-a. The oplog remote writer 330 may consume requests from the internal local writer threads (e.g., of the oplog local writer 325) and may be responsible for coordinating the efficient transfer of oplog data from the local disk 335 to the remote storage environment 215-a. In some examples, the oplog remote writer 330 may initiate, instantiate, or use a remote worker thread pool which may be designed to handle the task of moving oplog data from the local disk 335 to the remote storage environment 215-a. The remote worker thread pool may transfer data from multiple oplogs to the remote storage environment 215-a in parallel. The oplog remote writer 330 may accordingly act as an orchestrator for the movement of oplog data from the local disk 335 to the remote storage environment while the remote worker thread pool may manage the actual data transfer, ensuring reliable and efficient backup operations.

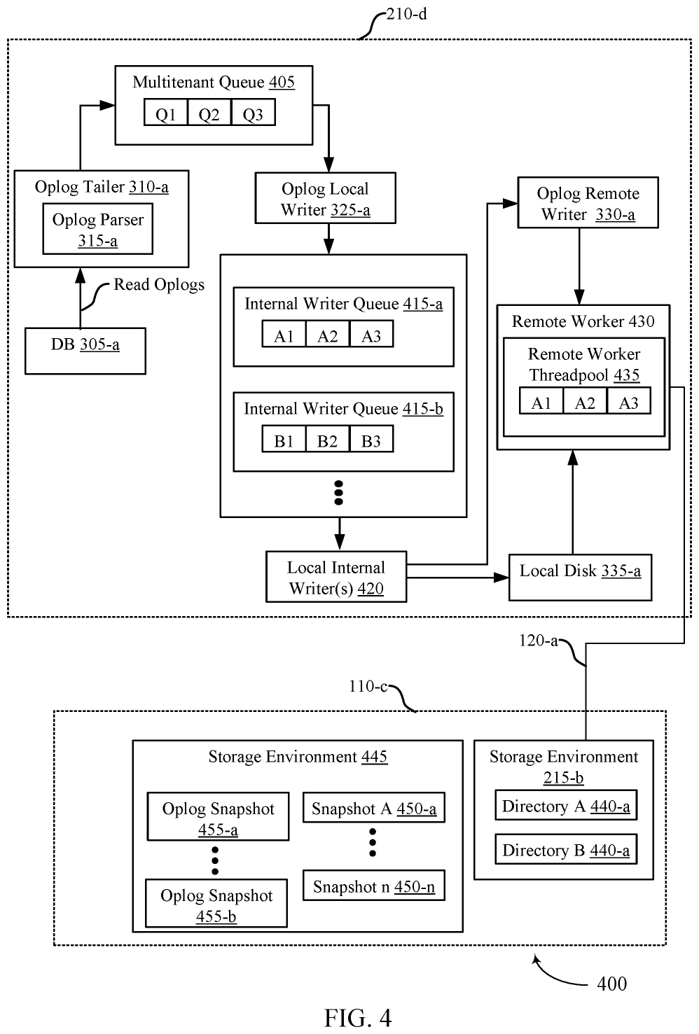

In some examples, the oplog tailer 310 and the oplog mover 320 (e.g., the oplog local writer 325 and the oplog remote writer 330) may be controlled, managed, or run by an agent 220 of the DMS 110-b at the non-relational database host 210-c. Use of an oplog tailer 310 and an oplog mover 320 to transfer oplog data to a remote storage environment 215-a may result in efficient parsing and filtering of oplogs for collections of the non-relational database host 210-c, may allow for fast oplog movement to the local disk 335 for multiple collections in parallel, and may allow for asynchronous oplog file movement to the remote storage environment 215-a for multiple collections in parallel. As described with reference to FIG. 4, the remote storage environment 215-a may include switchable active and passive directories such that oplogs may be continuously written to the remote storage environment 215-a on the currently active directory while a snapshot is taken of the currently passive directory.

FIG. 4 shows an example of an oplog backup process diagram 400 that supports backup management of operation logs for non-relational databases in accordance with aspects of the present disclosure. The oplog backup process diagram 400 may implement or may be implemented by one or more aspects of the computing environment 100, the diagram 200, or the oplog backup process diagram 300. For example, the oplog backup process diagram 400 includes a DMS 110-c which may be an example of the DMS 110 as described herein. The oplog backup process diagram 400 includes a non-relational database host 210-d, which may be an example of a non-relational database host 210 as described herein. The oplog backup process diagram 400 includes a remote storage environment 215-b, which may be an example of a remote storage environment 215 as described herein.

The DMS 110-c may provide backup and recovery services for the non-relational database 305-a, which may be an example of a non-relational database 305 as described herein and may be hosted at the non-relational database host 210-c. For example, an agent 220 of the DMS 110-c may extract data from one or more collections at the non-relational database 305-a and move the data (e.g., copy the data) to the remote storage environment 215-b or the remote storage environment 445. In some examples, the DMS 110-b may extract and store oplogs from the non-relational database 305-a, where the oplogs may indicate changes in collections of the non-relational database 305-a and may be stored in an oplog collection (e.g., an oplog.rs collection in the non-relational database 305-a).

The oplog tailer 310-a may be an example of an oplog tailer 310 as described herein. The oplog tailer 310-a may include an oplog parser 315-a, which may be an example of an oplog parser 315 as described herein. The oplog tailer 310-a may be a dedicated thread initiated, instantiated, or used (e.g., by the agent 220 of the DMS 110-c) to tail the oplog.rs collection of the non-relational database 305-a, ensuring efficient parsing and filtering of oplogs. The oplog tailer 310-a may keep pace with incoming oplogs. For example, the oplog tailer 310-a may read the oplogs from working memory of the non-relational database host 210-d (e.g., random access memory), if possible given resources from the non-relational database host 210-d, as compared to reading the oplogs from disk memory of non-relational database host 210-d. In some examples, the oplog tailer 310-a may read oplogs from the local disk of the non-relational database host 210-d (e.g., the oplog.rs collection), foe example, if the oplog tailing performed by the oplog tailer 310-a falls behind the generation of oplogs. The oplog tailer 310-a and/or the oplog parser 315-a may read parsed oplogs into a multitenant queue 405 in working memory of the non-relational database host 210-d. The multitenant queue 405 may temporarily store the oplogs for multiple (e.g., all or any) collections of the non-relational database 305-a, allowing for streamlined processing and filtering of oplogs. The oplog.rs collection may be a capped collection, meaning that the oplog.rs collection may have a maximum size. As the size of the oplog.rs collection reaches the threshold size, oplogs may roll over (e.g., older oplogs may be deleted). As the oplog tailer 310-a may read oplogs as the oplogs are generated, backups of oplogs may not be missed due to rollover, thereby ensuring continuous and efficient parsing of oplogs for the multiple collections of the non-relational database 305-a.

As described with reference to FIG. 3, the non-relational database host 210-d may include an oplog mover 320. The oplog mover of the non-relational database host 210-d may include an oplog local writer 325-a, internal writer queues 415, a local internal writer 420, an oplog remote writer 330-a, and a remote worker 430 including a remote worker thread pool 435. The oplog mover may address the potential bottleneck caused by writing oplog data to the backup storage over a network 120-a (e.g., a network 120 as described with reference to FIG. 1) via using the local disk 335-a of the non-relational database host 210-d. The speed of the network 120-a may be slower than the speed at which oplogs may be moved internally within the non-relational database host 210-d, and accordingly the local disk 335-a may be used as a buffer to keep up with the speed of the oplog tailer 310-a and the oplog mover (e.g., the oplog local writer 325-a and/or the local internal writer 420). For example, oplog data may be written to the local disk 335-a before being moved to the remote storage environment 215-b over the network 120-a, where writing to the local disk 335-a may be faster than writing to the remote storage environment 215-b over the network 120-a. Oplog data may be gradually moved from the local disk 335-a to the remote storage environment 215-b, for example, at a pace based on the network speed. For example, the oplog data may be moved from the local disk 335-a to the remote storage environment 215-b at a pace that does not overwhelm the network 120-a, ensuring a smoother and efficient movement of oplog data to the remote storage environment 215-b while avoiding bottlenecks.

The oplog mover may achieve efficient movement of oplog data in parallel from the multitenant queue 405 to the local disk 335-a. The oplog local writer 325-a may operate as an orchestrator which may consume oplogs from the multitenant queue 405 and may be responsible for the movement of oplogs from the multitenant queue 405 to the local disk 335-a. The oplog local writer 325-a may move oplogs from the multitenant queue 405 to internal writer queues 415 in the working memory of the non-relational database host 210-d. Each internal writer queue 415 may have a corresponding local internal writer 420 responsible for writing oplog data from the corresponding internal writer queue 415 to the local disk for a specific collection. For example, each internal writer queue 415 may include oplog data associated with one collection at a time. For example, the oplog local writer 325-a may move oplogs from the multitenant queue to the internal writer queue 415 that corresponds to the collection associated with the given oplog. The internal writer queues may hold the file handle of the collection file at the local disk 335-a where the oplog data is written.

Oplog data may be flushed from the internal writer queues 415 in response to one or more conditions. For example, when data is flushed from the internal writer queues 415, the data may be written by the corresponding local internal writer 420 from the internal writer queue to the local disk 335-a. A first condition for flushing an internal writer queue 415 may be that the memory usage of the internal writer queue 415 reaches a threshold. A second condition for flushing an internal writer queue 415 may be that an oplog for a different collection arrives at the queue. For example, if the internal writer queue 415-a stores oplog data for a first collection, the local internal writer 420 for the internal writer queue 415-a may flush the oplog data for the first collection when the oplog local writer 325-a moves an oplog for a second collection to the internal writer queue 415-a. A third condition for flushing an internal writer queue 415 may be the detection of a marker oplog by the agent 220 of the DMS 110-c. Such conditions may avoid flushing individual oplogs, and instead oplog data may be accumulated in working memory of the non-relational database host 210-d (e.g., in the internal writer queues 415) and flushed to the disk in a batch, reducing I/O cycles.

Utilization of multiple local internal writers 420 and multiple internal writer queues 415 may enable movement of oplog data from different collections to the local disk 335-a in parallel. Each collection may be mapped to a specific internal writer queue 415 (e.g., collection 1 may be mapped to internal writer queue 415-a, collection 2 may be mapped to internal writer queue 415-b, etc.) allowing for efficient processing of oplogs by the oplog local writer 325-a. If the quantity of collections increases, the quantity of local internal writers 420 and internal writer queues 415 may similarly be scaled to handle the additional collections.

The agent 220 of the DMS 110-c may perform asynchronous movement of oplog data to the remote storage environment 215-b. The oplog remote writer 330-a may operate as an orchestrator thread, which may consume local oplog files for all collections of the non-relational database 305-a and may handle the movement of oplog data to the remote storage environment 215-b. The remote worker 430 may create a pool of remote worker threads which may function as a remote worker thread pool 435 (e.g., a multi-tenant thread pool) serving write requests for all collections of the non-relational database 305-a. Each thread of the remote worker thread pool 435 may be capable of handling multiple collections simultaneously. When a local internal writer 420 moves an oplog to the local disk 335-a, the local internal writer 420 may submit a request to the oplog remote writer 330-a to append data from the local collection files in the local disk 335-a to the remote storage environment 215-b. For example, the oplogs may be stored in the local disk 335-a in local collection files. In some examples, each collection may have a corresponding collection file at the local disk 335-a to which oplogs for the given collections are written. In some examples, the local internal writer 420 may submit a request to append data from the local collection files in the local disk 335-a to the remote storage environment 215-b when the file size of a local collection file exceeds a threshold size or when a marker oplog is detected. The oplog remote writer 330-a may cause the remote worker 430 to move oplog data for multiple collections from the local disk to the remote storage environment 215-b in parallel. The remote worker 430 may handle the write requests from the oplog remote writer 330-a in a manner to ensure optimal performance and parallel processing. As the quantity of collections increases, the quantity of threads in the remote worker thread pool 435 may be increased to handle the increased workload.

In some examples, the DMS 110-c may obtain snapshots 450 of the non-relational database 305-a, for example in a remote storage environment 445. In some examples, the oplogs may be used in combination with the snapshots 450 to provide point-in-time recovery options, as snapshots may capture the state of the non-relational database 305-a periodically and the oplogs may show changes that occurred to the collections of the non-relational database 305-a between the snapshots. Additionally, or alternatively, the oplogs may be used to synchronize snapshots 455 of the non-relational database 305-a from different hosts of the non-relational database 305-a. For example, the DMS 110-c may capture a first subset of the collections of the non-relational database 305-a from the non-relational database host 210-d and may capture a second subset of the collections of the non-relational database 305-a from another host of the non-relational database host. In such an example, oplogs that capture changes to the non-relational database 305-a during the process to obtain the subsets of the collections may be used to synchronize the captured collections into a single snapshot.

In some examples, the DMS may capture a snapshot 455 of a directory 440 of the remote storage environment 215-b in which the oplogs are stored. For example, the snapshots 455 may be stored at the remote storage environment 445 (e.g., the same remote storage environment as the snapshots 450). To avoid pausing writing of oplogs to the remote storage environment 215-b while capturing a snapshot of the directory 440 in which oplogs are stored, the remote storage environment 215-b may include two directories 440 for storing oplogs. While a snapshot of one directory 440 (e.g., the directory 440-a) is being captured by the DMS 110-c, the directory may be considered a passive directory and the remote worker 430 may write oplogs to the other directory (e.g., the directory 440-b), which may be considered an active directory. Conversely, while a snapshot of the directory 440-b is being captured by the DMS 110-c, the directory 440-b may be considered the passive directory and the remote worker 430 may write oplogs to the directory 440-a. By switching the roles of the directories, the DMS 110-c may ensure that the oplog backup operations may continue without pausing, thereby providing flexibility to maintain log backup operation based on transitions between active and passive directories.

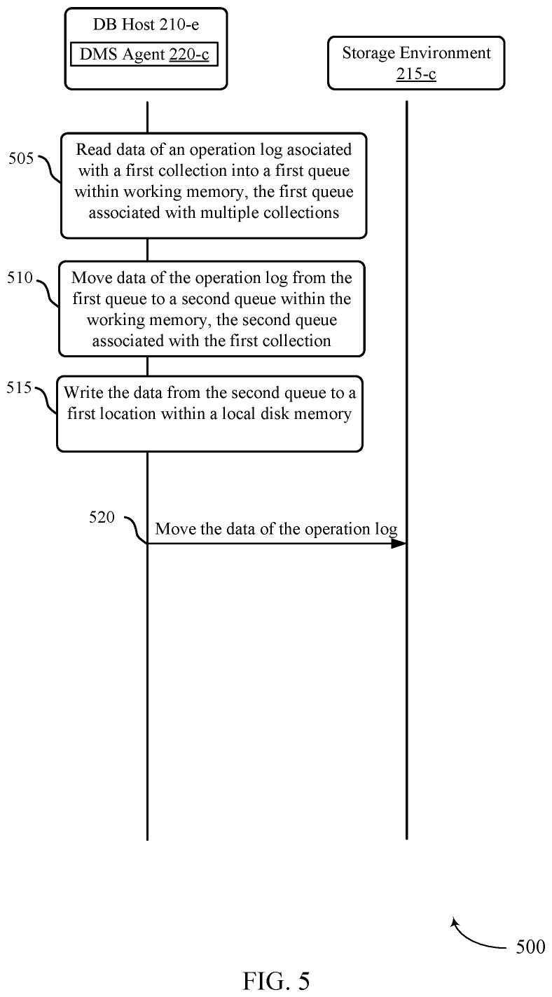

FIG. 5 shows an example of a process flow 500 that supports backup management of operation logs for non-relational databases in accordance with aspects of the present disclosure. The process flow 500 may implement or may be implemented by one or more aspects of the computing environment 100, the diagram 200, the oplog backup process diagram 300, or the oplog backup process diagram 400. For example, the process flow 500 may include a non-relational database host 210-e, which may be an example of a non-relational database host 210 as described herein. The process flow 500 may include a remote storage environment 215-c, which may be an example of a remote storage environment 215 as described herein. The process flow 500 may include an agent 220-c of a DMS 110 at the non-relational database host, where the DMS may manage backup and recovery services for a non-relational database hosted by the non-relational database host 210. In the following description of the process flow 500, operations between the non-relational database host 210-e, the agent 220-c, and the remote storage environment 215-c may be added, omitted, or performed in a different order (with respect to the exemplary order shown).

At 505, the agent 220-c at the non-relational database host 210-c may read data of an operation log into a first queue (e.g., a multitenant queue 405 as described herein) within working memory of the non-relational database host 210-c. The data of the operation log may be indicative of one or more modified documents in a first collection of a non-relational database hosted by the non-relational database host 210-c, and the first queue may be associated with a set of multiple collections of the non-relational database, the set of multiple collections including the first collection. For example, the agent 220-c may cause an oplog tailer 310 and/or an oplog parser 315 as described herein to read data of the operation log into a first queue.

At 510, the agent 220-c may move the data of the operation log from the first queue to a second queue (e.g., an internal writer queue 415 as described herein) within the working memory of the non-relational database host 210-c based on the operation log being indicative of the one or more modified documents in the first collection and based on the second queue being associated with the first collection. For example, the agent 220-c may cause an oplog local writer 325 as described herein to move the data of the operation log from the first queue to a second queue within the working memory.

At 515, the agent 220-c may write data of the operation log from the second queue to a first location within a local disk memory (e.g., a local disk 335 as described herein) of the non-relational database host 210-c. For example, the agent 220-c may cause a local internal writer 420 as described herein to write data of the operation log from the second queue to the first location within the local disk memory.

At 520, the agent 220-c may move the data of the operation log from the first location within the local disk memory to the remote storage environment 215-c. The remote storage environment 215-c may be accessible to the DMS 110.

In some examples, the agent 220-c may determine a generation of the operation log for addition to an operation log collection of the non-relational database hosted by the non-relational database host 210-c, and reading the data of the operation log into the first queue may be based on determining the generation of the operation log. In some examples, reading the data of the operation log into the first queue at 505 occurs prior to the addition of the operation log to the operation log collection.

In some examples, the agent 220-c may determine, based on reading the data of the operation log into the first queue at 505, that the operation log is associated with the first collection.

In some examples, the agent 220-c may read second data of a second operation log into the first queue, where the second data of the second operation log is indicative of one or more second modified documents in the first collection. In such examples, the agent 220-c may move the second data of the second operation log from the first queue to the second queue based on the second operation log being indicative of the one or more second modified documents in the first collection and based on the second queue being associated with the first collection. In such examples, the agent 220-c may write the data of the second operation log from the second queue to the first location within the local disk memory. In such examples, the agent 220-c may move the second data of the second operation log from the first location within the local disk memory to the remote storage environment 215-c.

In some examples, the agent 220-c may read second data of a second operation log into the first queue, where the second data of the second operation log is indicative of one or more second modified documents in a second collection of the non-relational database, the set of multiple collections including the second collection. In such examples, the agent 220-c may move, subsequent to writing the data of the operation log from the second queue to the first location, the second data of the second operation log from the first queue to the second queue based on the second operation log being indicative of the one or more second modified documents in the second collection and based on the second queue being associated with the second collection, where the second queue becomes associated with the second collection after the data of the operation log is written from the second queue to the first location within the local disk memory of the host. In such examples, the agent 220-c may write the second data of the second operation log from the second queue to a second location within the local disk memory. In such examples, the agent 220-c may move the second data of the second operation log from the second location within the local disk memory to the remote storage environment 215-c.

In some examples, the agent 220-c may read second data of a second operation log into the first queue, wherein the second data of the second operation log is indicative of one or more second modified documents in a second collection of the non-relational database, the set of multiple collections including the second collection. In such examples, the agent 220-c may move the second data of the second operation log from the first queue to a third queue within the working memory of the non-relational database host 210-c based on the second operation log being indicative of the one or more second modified documents in the second collection and on the third queue being associated with the second collection. In such examples, the agent 220-c may write the second data of the second operation log from the third queue to a second location within the local disk memory. In such examples, the agent 220-c may move the second data of the second operation log from the second location within the local disk memory to the remote storage environment 215-c. In some examples, the agent 220-c may write the data of the operation log from the second queue to the first location and writing the second data of the second operation log from the third queue to the second location in parallel.

In some examples, the agent 220-c may determine that an amount of data in the second queue satisfies a threshold. In such examples, writing the data of the operation log from the second queue to the first location at 515 may be based on determining that the amount of data in the second queue satisfies the threshold.

In some examples, second data of a second operation log associated with a second collection may be received at the second queue, and the set of multiple collections may include the second collection. In such examples, writing the data of the operation log from the second queue to the first location at 515 may be based on reception at the second queue of the second data of the second operation log.

In some examples, the agent 220-c may insert a marker document into a designated collection of the plurality of collections. In such examples, the agent 220-c may read a second operation log indicative of insertion of the marker document into the designated collection. In such examples, writing the data of the operation log from the second queue to the first location at 515 may be based on reading of the second operation log.

In some examples, the agent 220-c may move the data of the operation log from the first location within the local disk memory to the remote storage environment 215-c and may move second data of a second operation log associated with a second collection from a second location in the local disk memory to the remote storage environment 215-c in parallel, where the set of multiple collections may include the second collection.

In some examples, DMS 110 may obtain, during a first time period, a snapshot of a first directory of the remote storage environment 215-c, and moving the data of the operation log from the first location within the local disk memory to the remote storage environment at 520 may involve moving the data to a second directory of the remote storage environment 215-c during the first time period based on the DMS 110 obtaining the snapshot during the first time period. In some examples, the agent 220-c may move, during a second time period subsequent to the first time period, second data of a second operation log associated with a second collection from a second location in the local disk memory to the first directory of the remote storage environment 215-c based on the DMS 110 obtaining a second snapshot of the second directory during the second time period.

In some examples, the DMS 110 may update a snapshot of the non-relational database based on data of the operation log, where the DMS 110 initiated a capture of the snapshot prior to a time at which the one or more modified documents were modified.

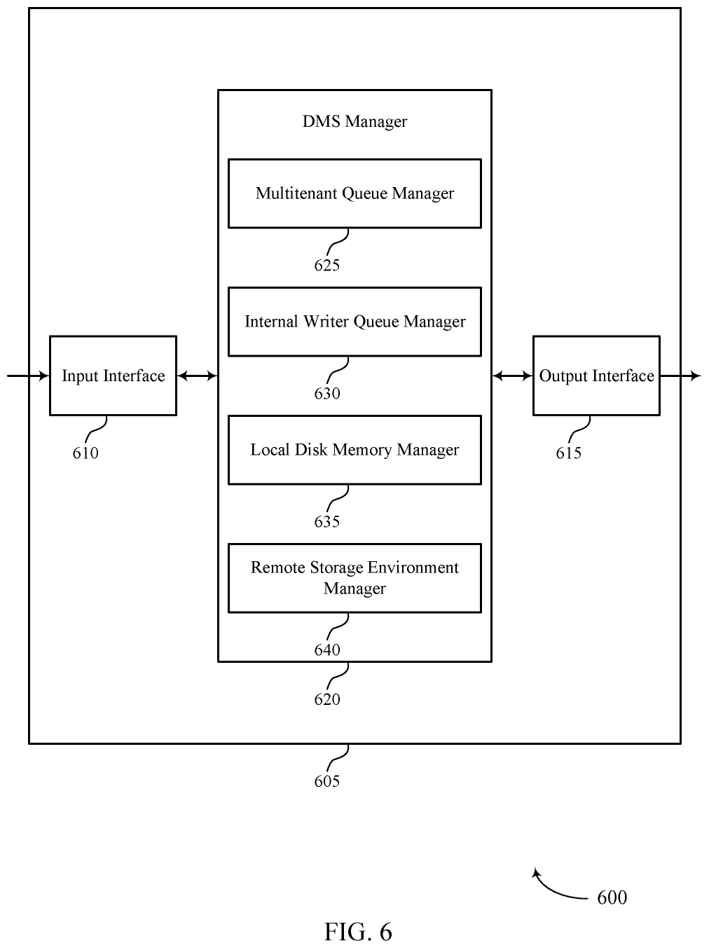

FIG. 6 shows a block diagram 600 of a system 605 that supports backup management of operation logs for non-relational databases in accordance with aspects of the present disclosure. In some examples, the system 605 may be an example of aspects of one or more components described with reference to FIG. 1, such as a DMS 110. The system 605 may include an input interface 610, an output interface 615, and a DMS Manager 620. The system 605 may also include one or more processors. Each of these components may be in communication with one another (e.g., via one or more buses, communications links, communications interfaces, or any combination thereof).

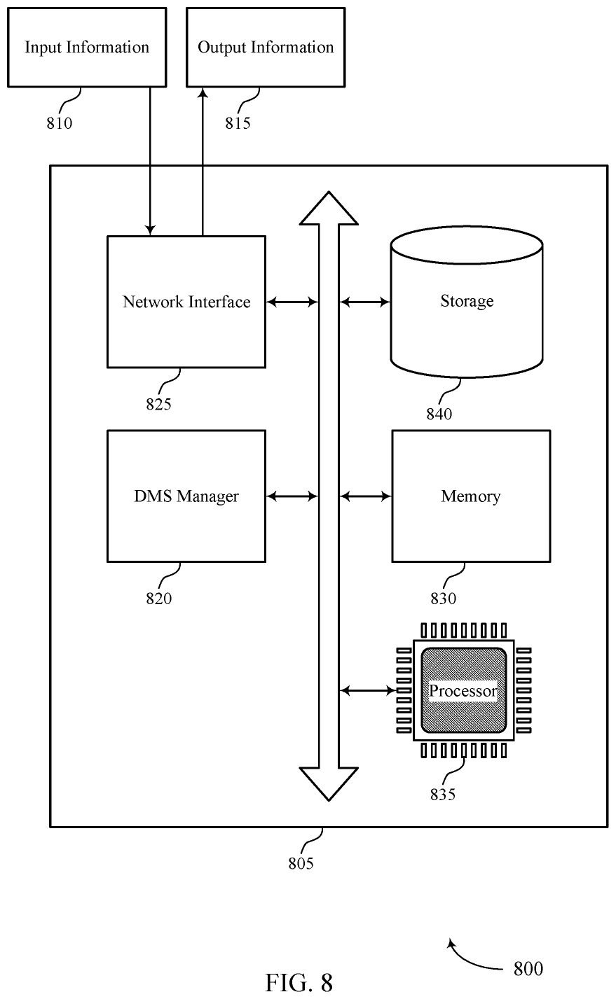

The input interface 610 may manage input signaling for the system 605. For example, the input interface 610 may receive input signaling (e.g., messages, packets, data, instructions, commands, or any other form of encoded information) from other systems or devices. The input interface 610 may send signaling corresponding to (e.g., representative of or otherwise based on) such input signaling to other components of the system 605 for processing. For example, the input interface 610 may transmit such corresponding signaling to the DMS Manager 620 to support backup management of operation logs for non-relational databases. In some cases, the input interface 610 may be a component of a network interface 825 as described with reference to FIG. 8.

The output interface 615 may manage output signaling for the system 605. For example, the output interface 615 may receive signaling from other components of the system 605, such as the DMS Manager 620, and may transmit such output signaling corresponding to (e.g., representative of or otherwise based on) such signaling to other systems or devices. In some cases, the output interface 615 may be a component of a network interface 825 as described with reference to FIG. 8.

For example, the DMS Manager 620 may include a multitenant queue manager 625, an internal writer queue manager 630, a local disk memory manager 635, a remote storage environment manager 640, or any combination thereof. In some examples, the DMS Manager 620, or various components thereof, may be configured to perform various operations (e.g., receiving, monitoring, transmitting) using or otherwise in cooperation with the input interface 610, the output interface 615, or both. For example, the DMS Manager 620 may receive information from the input interface 610, send information to the output interface 615, or be integrated in combination with the input interface 610, the output interface 615, or both to receive information, transmit information, or perform various other operations as described herein.

The DMS Manager 620 may support data management in accordance with examples as disclosed herein. The multitenant queue manager 625 may be configured as or otherwise support a means for reading, by an agent of a DMS at a host of a non-relational database, data of an operation log into a first queue within working memory of the host, where the data of the operation log is indicative of one or more modified documents in a first collection of the non-relational database, and where the first queue is associated with a set of multiple collections of the non-relational database, the set of multiple collections including the first collection. The internal writer queue manager 630 may be configured as or otherwise support a means for moving, by the agent, the data of the operation log from the first queue to a second queue within the working memory of the host based on the operation log being indicative of the one or more modified documents in the first collection and based on the second queue being associated with the first collection. The local disk memory manager 635 may be configured as or otherwise support a means for writing, by the agent, the data of the operation log from the second queue to a first location within a local disk memory of the host. The remote storage environment manager 640 may be configured as or otherwise support a means for moving, by the agent, the data of the operation log from the first location within the local disk memory to a remote storage environment accessible to the DMS.

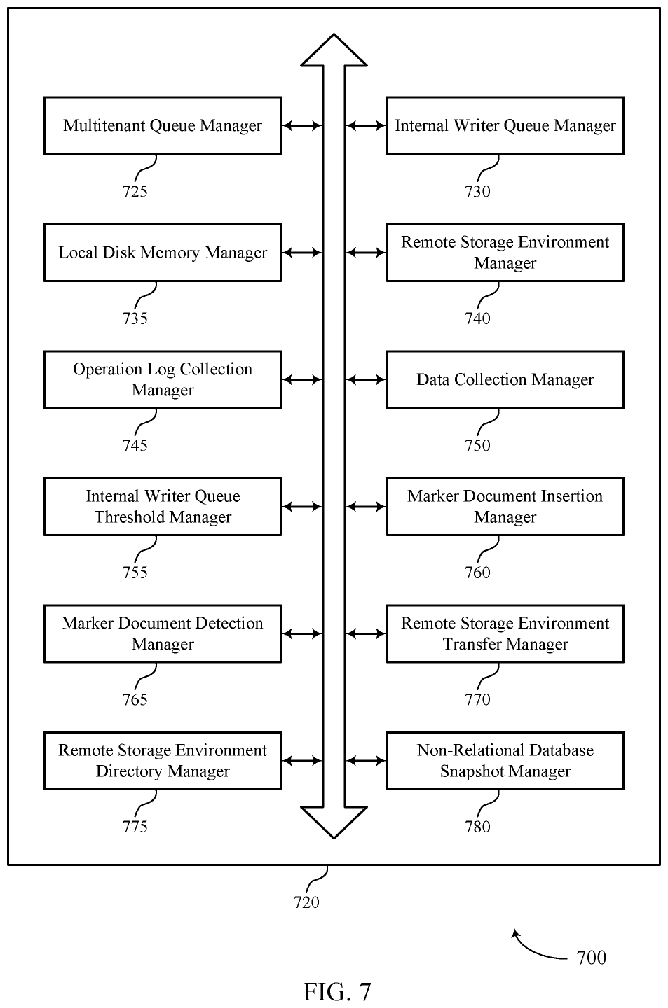

FIG. 7 shows a block diagram 700 of a DMS Manager 720 that supports backup management of operation logs for non-relational databases in accordance with aspects of the present disclosure. The DMS Manager 720 may be an example of aspects of a DMS Manager or a DMS Manager 620, or both, as described herein. The DMS Manager 720, or various components thereof, may be an example of means for performing various aspects of backup management of operation logs for non-relational databases as described herein. For example, the DMS Manager 720 may include a multitenant queue manager 725, an internal writer queue manager 730, a local disk memory manager 735, a remote storage environment manager 740, an operation log collection manager 745, a data collection manager 750, an internal writer queue threshold manager 755, a marker document insertion manager 760, a marker document detection manager 765, a remote storage environment transfer manager 770, a remote storage environment directory manager 775, a non-relational database snapshot manager 780, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The DMS Manager 720 may support data management in accordance with examples as disclosed herein. The multitenant queue manager 725 may be configured as or otherwise support a means for reading, by an agent of a DMS at a host of a non-relational database, data of an operation log into a first queue within working memory of the host, where the data of the operation log is indicative of one or more modified documents in a first collection of the non-relational database, and where the first queue is associated with a set of multiple collections of the non-relational database, the set of multiple collections including the first collection. The internal writer queue manager 730 may be configured as or otherwise support a means for moving, by the agent, the data of the operation log from the first queue to a second queue within the working memory of the host based on the operation log being indicative of the one or more modified documents in the first collection and based on the second queue being associated with the first collection. The local disk memory manager 735 may be configured as or otherwise support a means for writing, by the agent, the data of the operation log from the second queue to a first location within a local disk memory of the host. The remote storage environment manager 740 may be configured as or otherwise support a means for moving, by the agent, the data of the operation log from the first location within the local disk memory to a remote storage environment accessible to the DMS.

In some examples, the operation log collection manager 745 may be configured as or otherwise support a means for determining, by the agent, a generation of the operation log for addition to an operation log collection of the non-relational database, where reading the data of the operation log into the first queue is based on determining the generation of the operation log.

In some examples, reading the data of the operation log into the first queue occurs prior to the addition of the operation log to the operation log collection.

In some examples, the data collection manager 750 may be configured as or otherwise support a means for determining, based on reading the data of the operation log into the first queue, that the operation log is associated with the first collection.

In some examples, the multitenant queue manager 725 may be configured as or otherwise support a means for reading, by the agent, second data of a second operation log into the first queue, where the second data of the second operation log is indicative of one or more second modified documents in the first collection. In some examples, the internal writer queue manager 730 may be configured as or otherwise support a means for moving, by the agent, the second data of the second operation log from the first queue to the second queue based on the second operation log being indicative of the one or more second modified documents in the first collection and based on the second queue being associated with the first collection. In some examples, the local disk memory manager 735 may be configured as or otherwise support a means for writing, by the agent, the data of the second operation log from the second queue to the first location within the local disk memory. In some examples, the remote storage environment manager 740 may be configured as or otherwise support a means for moving, by the agent, the second data of the second operation log from the first location within the local disk memory to the remote storage environment.

In some examples, the multitenant queue manager 725 may be configured as or otherwise support a means for reading, by the agent, second data of a second operation log into the first queue, where the second data of the second operation log is indicative of one or more second modified documents in a second collection of the non-relational database, the set of multiple collections including the second collection. In some examples, the internal writer queue manager 730 may be configured as or otherwise support a means for moving, by the agent, the second data of the second operation log from the first queue to a third queue within the working memory of the host based on the second operation log being indicative of the one or more second modified documents in the second collection and based on the third queue being associated with the second collection. In some examples, the local disk memory manager 735 may be configured as or otherwise support a means for writing, by the agent, the second data of the second operation log from the third queue to a second location within the local disk memory. In some examples, the remote storage environment manager 740 may be configured as or otherwise support a means for moving, by the agent, the second data of the second operation log from the second location within the local disk memory to the remote storage environment.

In some examples, the local disk memory manager 735 may be configured as or otherwise support a means for writing the data of the operation log from the second queue to the first location and writing the second data of the second operation log from the third queue to the second location in parallel.

In some examples, the multitenant queue manager 725 may be configured as or otherwise support a means for reading, by the agent, second data of a second operation log into the first queue, where the second data of the second operation log is indicative of one or more second modified documents in a second collection of the non-relational database, the set of multiple collections including the second collection. In some examples, the internal writer queue manager 730 may be configured as or otherwise support a means for moving, by the agent and subsequent to writing the data of the operation log from the second queue to the first location, the second data of the second operation log from the first queue to the second queue based on the second operation log being indicative of the one or more second modified documents in the second collection and based on the second queue being associated with the second collection, where the second queue becomes associated with the second collection after the data of the operation log is written from the second queue to the first location within the local disk memory of the host. In some examples, the local disk memory manager 735 may be configured as or otherwise support a means for writing, by the agent, the second data of the second operation log from the second queue to a second location within the local disk memory. In some examples, the remote storage environment manager 740 may be configured as or otherwise support a means for moving, by the agent, the second data of the second operation log from the second location within the local disk memory to the remote storage environment.

In some examples, the internal writer queue threshold manager 755 may be configured as or otherwise support a means for determining that an amount of data in the second queue satisfies a threshold, where writing the data of the operation log from the second queue to the first location is based on determining that the amount of data in the second queue satisfies the threshold.

In some examples, the internal writer queue manager 730 may be configured as or otherwise support a means for receiving, at the second queue, second data of a second operation log associated with a second collection, where the set of multiple collections includes the second collection, and where writing the data of the operation log from the second queue to the first location is based on reception at the second queue of the second data of the second operation log.

In some examples, the marker document insertion manager 760 may be configured as or otherwise support a means for inserting, by the agent, a marker document into a designated collection of the set of multiple collections. In some examples, the marker document detection manager 765 may be configured as or otherwise support a means for reading, by the agent, a second operation log indicative of insertion of the marker document into the designated collection, where writing the data of the operation log from the second queue to the first location is based on reading of the second operation log.

In some examples, the remote storage environment transfer manager 770 may be configured as or otherwise support a means for moving the data of the operation log from the first location within the local disk memory to the remote storage environment and moving second data of a second operation log associated with a second collection from a second location in the local disk memory to the remote storage environment in parallel, where the set of multiple collections includes the second collection.

In some examples, the remote storage environment directory manager 775 may be configured as or otherwise support a means for obtaining, by the DMS during a first time period, a snapshot of a first directory of the remote storage environment, where moving the data of the operation log from the first location within the local disk memory to the remote storage environment includes moving the data to a second directory of the remote storage environment during the first time period based on the DMS obtaining the snapshot during the first time period.

In some examples, the remote storage environment directory manager 775 may be configured as or otherwise support a means for moving, during a second time period subsequent to the first time period, second data of a second operation log associated with a second collection from a second location in the local disk memory to the first directory of the remote storage environment based on the DMS obtaining a second snapshot of the second directory during the second time period.

In some examples, the non-relational database snapshot manager 780 may be configured as or otherwise support a means for updating, by the DMS, a snapshot of the non-relational database based on data of the operation log, where the DMS initiated a capture of the snapshot prior to a time at which the one or more modified documents were modified.

FIG. 8 shows a block diagram 800 of a system 805 that supports backup management of operation logs for non-relational databases in accordance with aspects of the present disclosure. The system 805 may be an example of or include components of a system 605 as described herein. The system 805 may include components for data management, including components such as a DMS manager 820, an input information 810, an output information 815, a network interface 825, at least one memory 830, at least one processor 835, and a storage 840. These components may be in electronic communication or otherwise coupled with each other (e.g., operatively, communicatively, functionally, electronically, electrically; via one or more buses, communications links, communications interfaces, or any combination thereof). Additionally, the components of the system 805 may include corresponding physical components or may be implemented as corresponding virtual components (e.g., components of one or more virtual machines). In some examples, the system 805 may be an example of aspects of one or more components described with reference to FIG. 1, such as a DMS 110.

The network interface 825 may enable the system 805 to exchange information (e.g., input information 810, output information 815, or both) with other systems or devices (not shown). For example, the network interface 825 may enable the system 805 to connect to a network (e.g., a network 120 as described herein). The network interface 825 may include one or more wireless network interfaces, one or more wired network interfaces, or any combination thereof. In some examples, the network interface 825 may be an example of may be an example of aspects of one or more components described with reference to FIG. 1, such as one or more network interfaces 165.

Memory 830 may include RAM, ROM, or both. The memory 830 may store computer-readable, computer-executable software including instructions that, when executed, cause the processor 835 to perform various functions described herein. In some cases, the memory 830 may contain, among other things, a basic input/output system (BIOS), which may control basic hardware or software operation such as the interaction with peripheral components or devices. In some cases, the memory 830 may be an example of aspects of one or more components described with reference to FIG. 1, such as one or more memories 175.

The processor 835 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 835 may be configured to execute computer-readable instructions stored in a memory 830 to perform various functions (e.g., functions or tasks supporting backup management of operation logs for non-relational databases). Though a single processor 835 is depicted in the example of FIG. 8, it is to be understood that the system 805 may include any quantity of one or more of processors 835 and that a group of processors 835 may collectively perform one or more functions ascribed herein to a processor, such as the processor 835. In some cases, the processor 835 may be an example of aspects of one or more components described with reference to FIG. 1, such as one or more processors 170.

Storage 840 may be configured to store data that is generated, processed, stored, or otherwise used by the system 805. In some cases, the storage 840 may include one or more HDDs, one or more SDDs, or both. In some examples, the storage 840 may be an example of a single database, a distributed database, multiple distributed databases, a data store, a data lake, or an emergency backup database. In some examples, the storage 840 may be an example of one or more components described with reference to FIG. 1, such as one or more network disks 180.

The DMS manager 820 may support data management in accordance with examples as disclosed herein. For example, the DMS Manager 820 may be configured as or otherwise support a means for reading, by an agent of a DMS at a host of a non-relational database, data of an operation log into a first queue within working memory of the host, where the data of the operation log is indicative of one or more modified documents in a first collection of the non-relational database, and where the first queue is associated with a set of multiple collections of the non-relational database, the set of multiple collections including the first collection. The DMS Manager 820 may be configured as or otherwise support a means for moving, by the agent, the data of the operation log from the first queue to a second queue within the working memory of the host based on the operation log being indicative of the one or more modified documents in the first collection and based on the second queue being associated with the first collection. The DMS Manager 820 may be configured as or otherwise support a means for writing, by the agent, the data of the operation log from the second queue to a first location within a local disk memory of the host. The DMS Manager 820 may be configured as or otherwise support a means for moving, by the agent, the data of the operation log from the first location within the local disk memory to a remote storage environment accessible to the DMS.

By including or configuring the DMS manager 820 in accordance with examples as described herein, the system 805 may support techniques for backup management of operation logs for non-relational databases, which may provide one or more benefits such as, for example, reduced latency, improved user experience, more efficient utilization of computing resources, network resources or both, or improved scalability, among other possibilities.

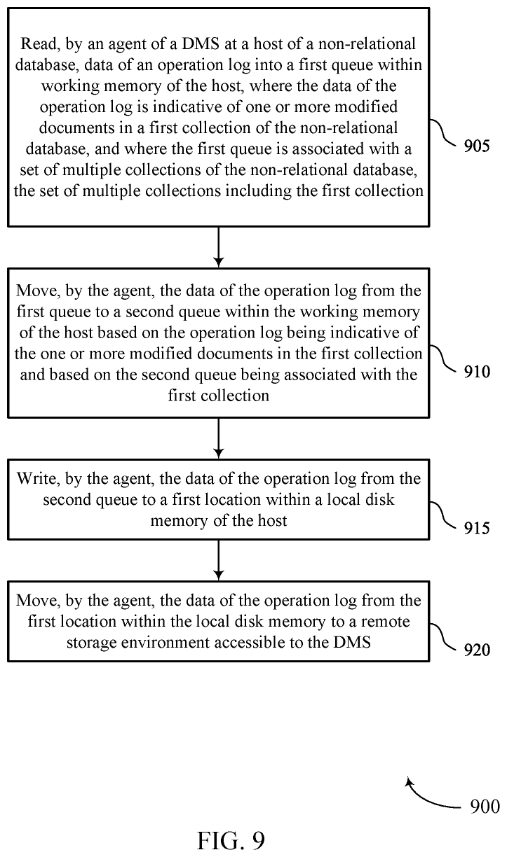

FIG. 9 shows a flowchart illustrating a method 900 that supports backup management of operation logs for non-relational databases in accordance with aspects of the present disclosure. The operations of the method 900 may be implemented by a DMS or its components as described herein. For example, the operations of the method 900 may be performed by a DMS as described with reference to FIGS. 1 through 8. In some examples, a DMS may execute a set of instructions to control the functional elements of the DMS to perform the described functions. Additionally, or alternatively, the DMS may perform aspects of the described functions using special-purpose hardware.

At 905, the method may include reading, by an agent of a DMS at a host of a non-relational database, data of an operation log into a first queue within working memory of the host, where the data of the operation log is indicative of one or more modified documents in a first collection of the non-relational database, and where the first queue is associated with a set of multiple collections of the non-relational database, the set of multiple collections including the first collection. The operations of 905 may be performed in accordance with examples as disclosed herein. In some examples, aspects of the operations of 905 may be performed by a multitenant queue manager 725 as described with reference to FIG. 7.

At 910, the method may include moving, by the agent, the data of the operation log from the first queue to a second queue within the working memory of the host based on the operation log being indicative of the one or more modified documents in the first collection and based on the second queue being associated with the first collection. The operations of 910 may be performed in accordance with examples as disclosed herein. In some examples, aspects of the operations of 910 may be performed by an internal writer queue manager 730 as described with reference to FIG. 7.

At 915, the method may include writing, by the agent, the data of the operation log from the second queue to a first location within a local disk memory of the host. The operations of 915 may be performed in accordance with examples as disclosed herein. In some examples, aspects of the operations of 915 may be performed by a local disk memory manager 735 as described with reference to FIG. 7.

At 920, the method may include moving, by the agent, the data of the operation log from the first location within the local disk memory to a remote storage environment accessible to the DMS. The operations of 920 may be performed in accordance with examples as disclosed herein. In some examples, aspects of the operations of 920 may be performed by a remote storage environment manager 740 as described with reference to FIG. 7.

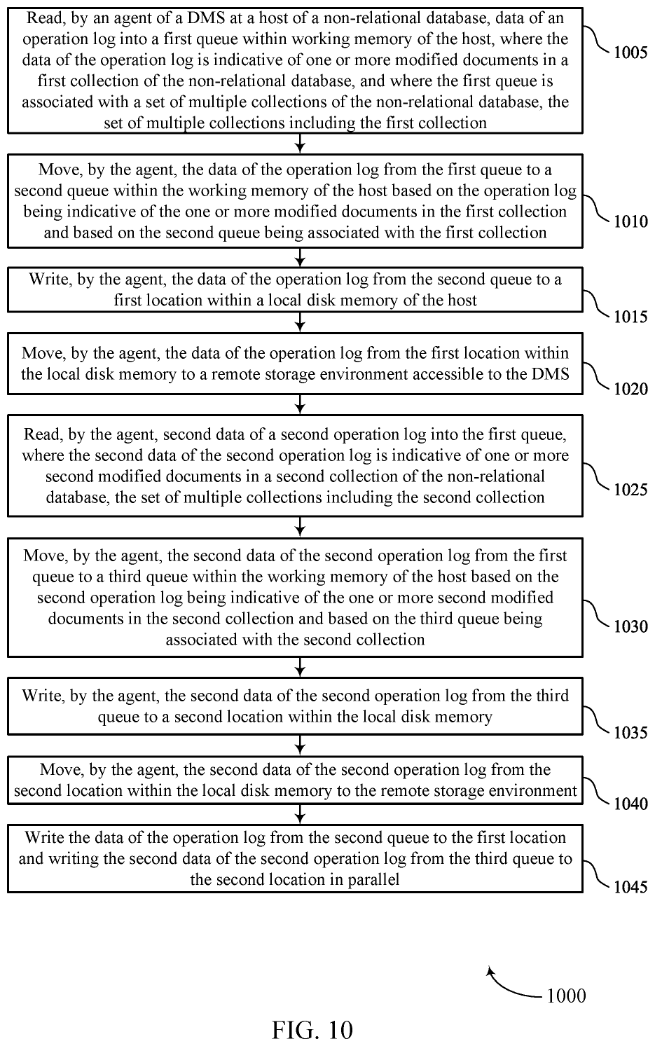

FIG. 10 shows a flowchart illustrating a method 1000 that supports backup management of operation logs for non-relational databases in accordance with aspects of the present disclosure. The operations of the method 1000 may be implemented by a DMS or its components as described herein. For example, the operations of the method 1000 may be performed by a DMS as described with reference to FIGS. 1 through 8. In some examples, a DMS may execute a set of instructions to control the functional elements of the DMS to perform the described functions. Additionally, or alternatively, the DMS may perform aspects of the described functions using special-purpose hardware.

At 1005, the method may include reading, by an agent of a DMS at a host of a non-relational database, data of an operation log into a first queue within working memory of the host, where the data of the operation log is indicative of one or more modified documents in a first collection of the non-relational database, and where the first queue is associated with a set of multiple collections of the non-relational database, the set of multiple collections including the first collection. The operations of 1005 may be performed in accordance with examples as disclosed herein. In some examples, aspects of the operations of 1005 may be performed by a multitenant queue manager 725 as described with reference to FIG. 7.

At 1010, the method may include moving, by the agent, the data of the operation log from the first queue to a second queue within the working memory of the host based on the operation log being indicative of the one or more modified documents in the first collection and based on the second queue being associated with the first collection. The operations of 1010 may be performed in accordance with examples as disclosed herein. In some examples, aspects of the operations of 1010 may be performed by an internal writer queue manager 730 as described with reference to FIG. 7.

At 1015, the method may include writing, by the agent, the data of the operation log from the second queue to a first location within a local disk memory of the host. The operations of 1015 may be performed in accordance with examples as disclosed herein. In some examples, aspects of the operations of 1015 may be performed by a local disk memory manager 735 as described with reference to FIG. 7.

At 1020, the method may include moving, by the agent, the data of the operation log from the first location within the local disk memory to a remote storage environment accessible to the DMS. The operations of 1020 may be performed in accordance with examples as disclosed herein. In some examples, aspects of the operations of 1020 may be performed by a remote storage environment manager 740 as described with reference to FIG. 7.

At 1025, the method may include reading, by the agent, second data of a second operation log into the first queue, where the second data of the second operation log is indicative of one or more second modified documents in a second collection of the non-relational database, the set of multiple collections including the second collection. The operations of 1025 may be performed in accordance with examples as disclosed herein. In some examples, aspects of the operations of 1025 may be performed by a multitenant queue manager 725 as described with reference to FIG. 7.

At 1030, the method may include moving, by the agent, the second data of the second operation log from the first queue to a third queue within the working memory of the host based on the second operation log being indicative of the one or more second modified documents in the second collection and based on the third queue being associated with the second collection. The operations of 1030 may be performed in accordance with examples as disclosed herein. In some examples, aspects of the operations of 1030 may be performed by an internal writer queue manager 730 as described with reference to FIG. 7.

At 1035, the method may include writing, by the agent, the second data of the second operation log from the third queue to a second location within the local disk memory. The operations of 1035 may be performed in accordance with examples as disclosed herein. In some examples, aspects of the operations of 1035 may be performed by a local disk memory manager 735 as described with reference to FIG. 7.

At 1040, the method may include moving, by the agent, the second data of the second operation log from the second location within the local disk memory to the remote storage environment. The operations of 1040 may be performed in accordance with examples as disclosed herein. In some examples, aspects of the operations of 1040 may be performed by a remote storage environment manager 740 as described with reference to FIG. 7.

At 1045, the method may include writing the data of the operation log from the second queue to the first location and writing the second data of the second operation log from the third queue to the second location in parallel. The operations of 1045 may be performed in accordance with examples as disclosed herein. In some examples, aspects of the operations of 1045 may be performed by a local disk memory manager 735 as described with reference to FIG. 7.

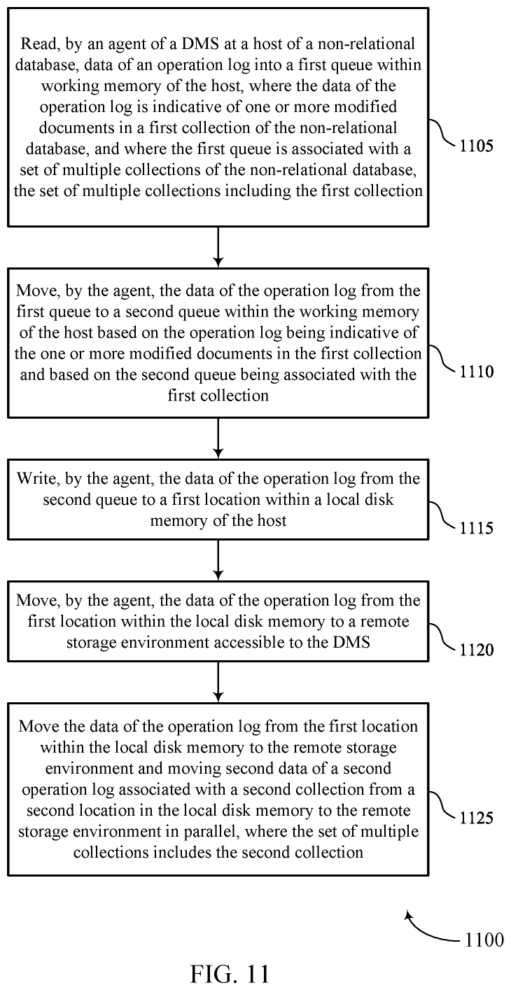

FIG. 11 shows a flowchart illustrating a method 1100 that supports backup management of operation logs for non-relational databases in accordance with aspects of the present disclosure. The operations of the method 1100 may be implemented by a DMS or its components as described herein. For example, the operations of the method 1100 may be performed by a DMS as described with reference to FIGS. 1 through 8. In some examples, a DMS may execute a set of instructions to control the functional elements of the DMS to perform the described functions. Additionally, or alternatively, the DMS may perform aspects of the described functions using special-purpose hardware.

At 1105, the method may include reading, by an agent of a DMS at a host of a non-relational database, data of an operation log into a first queue within working memory of the host, where the data of the operation log is indicative of one or more modified documents in a first collection of the non-relational database, and where the first queue is associated with a set of multiple collections of the non-relational database, the set of multiple collections including the first collection. The operations of 1105 may be performed in accordance with examples as disclosed herein. In some examples, aspects of the operations of 1105 may be performed by a multitenant queue manager 725 as described with reference to FIG. 7.

At 1110, the method may include moving, by the agent, the data of the operation log from the first queue to a second queue within the working memory of the host based on the operation log being indicative of the one or more modified documents in the first collection and based on the second queue being associated with the first collection. The operations of 1110 may be performed in accordance with examples as disclosed herein. In some examples, aspects of the operations of 1110 may be performed by an internal writer queue manager 730 as described with reference to FIG. 7.

At 1115, the method may include writing, by the agent, the data of the operation log from the second queue to a first location within a local disk memory of the host. The operations of 1115 may be performed in accordance with examples as disclosed herein. In some examples, aspects of the operations of 1115 may be performed by a local disk memory manager 735 as described with reference to FIG. 7.

At 1120, the method may include moving, by the agent, the data of the operation log from the first location within the local disk memory to a remote storage environment accessible to the DMS. The operations of 1120 may be performed in accordance with examples as disclosed herein. In some examples, aspects of the operations of 1120 may be performed by a remote storage environment manager 740 as described with reference to FIG. 7.

At 1125, the method may include moving the data of the operation log from the first location within the local disk memory to the remote storage environment and moving second data of a second operation log associated with a second collection from a second location in the local disk memory to the remote storage environment in parallel, where the set of multiple collections includes the second collection. The operations of 1125 may be performed in accordance with examples as disclosed herein. In some examples, aspects of the operations of 1125 may be performed by a remote storage environment transfer manager 770 as described with reference to FIG. 7.

A method for data management by an apparatus is described. The method may include reading, by an agent of a DMS at a host of a non-relational database, data of an operation log into a first queue within working memory of the host, where the data of the operation log is indicative of one or more modified documents in a first collection of the non-relational database, and where the first queue is associated with a set of multiple collections of the non-relational database, the set of multiple collections including the first collection, moving, by the agent, the data of the operation log from the first queue to a second queue within the working memory of the host based on the operation log being indicative of the one or more modified documents in the first collection and based on the second queue being associated with the first collection, writing, by the agent, the data of the operation log from the second queue to a first location within a local disk memory of the host, and moving, by the agent, the data of the operation log from the first location within the local disk memory to a remote storage environment accessible to the DMS.

An apparatus for data management is described. The apparatus may include one or more memories storing processor executable code, and one or more processors coupled with the one or more memories. The one or more processors may individually or collectively be operable to execute the code to cause the apparatus to read, by an agent of a DMS at a host of a non-relational database, data of an operation log into a first queue within working memory of the host, where the data of the operation log is indicative of one or more modified documents in a first collection of the non-relational database, and where the first queue is associated with a set of multiple collections of the non-relational database, the set of multiple collections including the first collection, move, by the agent, the data of the operation log from the first queue to a second queue within the working memory of the host based on the operation log being indicative of the one or more modified documents in the first collection and based on the second queue being associated with the first collection, write, by the agent, the data of the operation log from the second queue to a first location within a local disk memory of the host, and move, by the agent, the data of the operation log from the first location within the local disk memory to a remote storage environment accessible to the DMS.

Another apparatus for data management is described. The apparatus may include means for reading, by an agent of a DMS at a host of a non-relational database, data of an operation log into a first queue within working memory of the host, where the data of the operation log is indicative of one or more modified documents in a first collection of the non-relational database, and where the first queue is associated with a set of multiple collections of the non-relational database, the set of multiple collections including the first collection, means for moving, by the agent, the data of the operation log from the first queue to a second queue within the working memory of the host based on the operation log being indicative of the one or more modified documents in the first collection and based on the second queue being associated with the first collection, means for writing, by the agent, the data of the operation log from the second queue to a first location within a local disk memory of the host, and means for moving, by the agent, the data of the operation log from the first location within the local disk memory to a remote storage environment accessible to the DMS.

A non-transitory computer-readable medium storing code for data management is described. The code may include instructions executable by one or more processors to read, by an agent of a DMS at a host of a non-relational database, data of an operation log into a first queue within working memory of the host, where the data of the operation log is indicative of one or more modified documents in a first collection of the non-relational database, and where the first queue is associated with a set of multiple collections of the non-relational database, the set of multiple collections including the first collection, move, by the agent, the data of the operation log from the first queue to a second queue within the working memory of the host based on the operation log being indicative of the one or more modified documents in the first collection and based on the second queue being associated with the first collection, write, by the agent, the data of the operation log from the second queue to a first location within a local disk memory of the host, and move, by the agent, the data of the operation log from the first location within the local disk memory to a remote storage environment accessible to the DMS.

Some examples of the method, apparatus, and non-transitory computer-readable medium described herein may further include operations, features, means, or instructions for determining, by the agent, a generation of the operation log for addition to an operation log collection of the non-relational database, where reading the data of the operation log into the first queue may be based on determining the generation of the operation log.

Some examples of the method, apparatus, and non-transitory computer-readable medium described herein may further include operations, features, means, or instructions for reading the data of the operation log into the first queue occurs prior to the addition of the operation log to the operation log collection.

Some examples of the method, apparatus, and non-transitory computer-readable medium described herein may further include operations, features, means, or instructions for determining, based on reading the data of the operation log into the first queue, that the operation log may be associated with the first collection.

Some examples of the method, apparatus, and non-transitory computer-readable medium described herein may further include operations, features, means, or instructions for reading, by the agent, second data of a second operation log into the first queue, where the second data of the second operation log may be indicative of one or more second modified documents in the first collection, moving, by the agent, the second data of the second operation log from the first queue to the second queue based on the second operation log being indicative of the one or more second modified documents in the first collection and based on the second queue being associated with the first collection, writing, by the agent, the data of the second operation log from the second queue to the first location within the local disk memory, and moving, by the agent, the second data of the second operation log from the first location within the local disk memory to the remote storage environment.

Some examples of the method, apparatus, and non-transitory computer-readable medium described herein may further include operations, features, means, or instructions for reading, by the agent, second data of a second operation log into the first queue, where the second data of the second operation log may be indicative of one or more second modified documents in a second collection of the non-relational database, the set of multiple collections including the second collection, moving, by the agent, the second data of the second operation log from the first queue to a third queue within the working memory of the host based on the second operation log being indicative of the one or more second modified documents in the second collection and based on the third queue being associated with the second collection, writing, by the agent, the second data of the second operation log from the third queue to a second location within the local disk memory, and moving, by the agent, the second data of the second operation log from the second location within the local disk memory to the remote storage environment.

Some examples of the method, apparatus, and non-transitory computer-readable medium described herein may further include operations, features, means, or instructions for writing the data of the operation log from the second queue to the first location and writing the second data of the second operation log from the third queue to the second location in parallel.

Some examples of the method, apparatus, and non-transitory computer-readable medium described herein may further include operations, features, means, or instructions for reading, by the agent, second data of a second operation log into the first queue, where the second data of the second operation log may be indicative of one or more second modified documents in a second collection of the non-relational database, the set of multiple collections including the second collection, moving, by the agent and subsequent to writing the data of the operation log from the second queue to the first location, the second data of the second operation log from the first queue to the second queue based on the second operation log being indicative of the one or more second modified documents in the second collection and based on the second queue being associated with the second collection, where the second queue becomes associated with the second collection after the data of the operation log may be written from the second queue to the first location within the local disk memory of the host, writing, by the agent, the second data of the second operation log from the second queue to a second location within the local disk memory, and moving, by the agent, the second data of the second operation log from the second location within the local disk memory to the remote storage environment.

Some examples of the method, apparatus, and non-transitory computer-readable medium described herein may further include operations, features, means, or instructions for determining that an amount of data in the second queue satisfies a threshold, where writing the data of the operation log from the second queue to the first location may be based on determining that the amount of data in the second queue satisfies the threshold.

Some examples of the method, apparatus, and non-transitory computer-readable medium described herein may further include operations, features, means, or instructions for receiving, at the second queue, second data of a second operation log associated with a second collection, where the set of multiple collections includes the second collection, and where writing the data of the operation log from the second queue to the first location may be based on reception at the second queue of the second data of the second operation log.

Some examples of the method, apparatus, and non-transitory computer-readable medium described herein may further include operations, features, means, or instructions for inserting, by the agent, a marker document into a designated collection of the set of multiple collections and reading, by the agent, a second operation log indicative of insertion of the marker document into the designated collection, where writing the data of the operation log from the second queue to the first location may be based on reading of the second operation log.

Some examples of the method, apparatus, and non-transitory computer-readable medium described herein may further include operations, features, means, or instructions for moving the data of the operation log from the first location within the local disk memory to the remote storage environment and moving second data of a second operation log associated with a second collection from a second location in the local disk memory to the remote storage environment in parallel, where the set of multiple collections includes the second collection.

Some examples of the method, apparatus, and non-transitory computer-readable medium described herein may further include operations, features, means, or instructions for obtaining, by the DMS during a first time period, a snapshot of a first directory of the remote storage environment, where moving the data of the operation log from the first location within the local disk memory to the remote storage environment includes moving the data to a second directory of the remote storage environment during the first time period based on the DMS obtaining the snapshot during the first time period.

Some examples of the method, apparatus, and non-transitory computer-readable medium described herein may further include operations, features, means, or instructions for moving, during a second time period subsequent to the first time period, second data of a second operation log associated with a second collection from a second location in the local disk memory to the first directory of the remote storage environment based on the DMS obtaining a second snapshot of the second directory during the second time period.

Some examples of the method, apparatus, and non-transitory computer-readable medium described herein may further include operations, features, means, or instructions for updating, by the DMS, a snapshot of the non-relational database based on data of the operation log, where the DMS initiated a capture of the snapshot prior to a time at which the one or more modified documents were modified.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”′) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
reading, by an agent of a data management system (DMS) at a host of a non-relational database, data of an operation log into a first queue within working memory of the host, wherein the data of the operation log is indicative of one or more modified documents in a first collection of the non-relational database, and wherein the first queue is associated with a plurality of collections of the non-relational database, the plurality of collections comprising the first collection;
moving, by the agent, the data of the operation log from the first queue to a second queue within the working memory of the host based at least in part on the operation log being indicative of the one or more modified documents in the first collection and based at least in part on the second queue being associated with the first collection;
writing, by the agent, the data of the operation log from the second queue to a first location within a local disk memory of the host; and
moving, by the agent, the data of the operation log from the first location within the local disk memory to a remote storage environment accessible to the DMS.

2. The method of claim 1, further comprising:
determining, by the agent, a generation of the operation log for addition to an operation log collection of the non-relational database, wherein reading the data of the operation log into the first queue is based at least in part on determining the generation of the operation log.

3. The method of claim 2, wherein reading the data of the operation log into the first queue occurs prior to the addition of the operation log to the operation log collection.

4. The method of claim 1, further comprising:
determining, based at least in part on reading the data of the operation log into the first queue, that the operation log is associated with the first collection.

5. The method of claim 1, further comprising:
reading, by the agent, second data of a second operation log into the first queue, wherein the second data of the second operation log is indicative of one or more second modified documents in the first collection;
moving, by the agent, the second data of the second operation log from the first queue to the second queue based at least in part on the second operation log being indicative of the one or more second modified documents in the first collection and based at least in part on the second queue being associated with the first collection;
writing, by the agent, the data of the second operation log from the second queue to the first location within the local disk memory; and
moving, by the agent, the second data of the second operation log from the first location within the local disk memory to the remote storage environment.

6. The method of claim 1, further comprising:
reading, by the agent, second data of a second operation log into the first queue, wherein the second data of the second operation log is indicative of one or more second modified documents in a second collection of the non-relational database, the plurality of collections comprising the second collection;
moving, by the agent, the second data of the second operation log from the first queue to a third queue within the working memory of the host based at least in part on the second operation log being indicative of the one or more second modified documents in the second collection and based at least in part on the third queue being associated with the second collection;
writing, by the agent, the second data of the second operation log from the third queue to a second location within the local disk memory; and
moving, by the agent, the second data of the second operation log from the second location within the local disk memory to the remote storage environment.

7. The method of claim 6, further comprising:
writing the data of the operation log from the second queue to the first location and writing the second data of the second operation log from the third queue to the second location in parallel.

8. The method of claim 1, further comprising:
reading, by the agent, second data of a second operation log into the first queue, wherein the second data of the second operation log is indicative of one or more second modified documents in a second collection of the non-relational database, the plurality of collections comprising the second collection;
moving, by the agent and subsequent to writing the data of the operation log from the second queue to the first location, the second data of the second operation log from the first queue to the second queue based at least in part on the second operation log being indicative of the one or more second modified documents in the second collection and based at least in part on the second queue being associated with the second collection, wherein the second queue becomes associated with the second collection after the data of the operation log is written from the second queue to the first location within the local disk memory of the host;
writing, by the agent, the second data of the second operation log from the second queue to a second location within the local disk memory; and
moving, by the agent, the second data of the second operation log from the second location within the local disk memory to the remote storage environment.

9. The method of claim 1, further comprising:
determining that an amount of data in the second queue satisfies a threshold, wherein writing the data of the operation log from the second queue to the first location is based at least in part on determining that the amount of data in the second queue satisfies the threshold.

10. The method of claim 1, further comprising:
receiving, at the second queue, second data of a second operation log associated with a second collection, wherein the plurality of collections comprises the second collection, and wherein writing the data of the operation log from the second queue to the first location is based at least in part on reception at the second queue of the second data of the second operation log.

11. The method of claim 1, further comprising:
inserting, by the agent, a marker document into a designated collection of the plurality of collections; and
reading, by the agent, a second operation log indicative of insertion of the marker document into the designated collection, wherein writing the data of the operation log from the second queue to the first location is based at least in part on reading of the second operation log.

12. The method of claim 1, further comprising:
moving the data of the operation log from the first location within the local disk memory to the remote storage environment and moving second data of a second operation log associated with a second collection from a second location in the local disk memory to the remote storage environment in parallel, wherein the plurality of collections comprises the second collection.

13. The method of claim 1, further comprising:
obtaining, by the DMS during a first time period, a snapshot of a first directory of the remote storage environment, wherein moving the data of the operation log from the first location within the local disk memory to the remote storage environment comprises moving the data to a second directory of the remote storage environment during the first time period based at least in part on the DMS obtaining the snapshot during the first time period.

14. The method of claim 13, further comprising:
moving, during a second time period subsequent to the first time period, second data of a second operation log associated with a second collection from a second location in the local disk memory to the first directory of the remote storage environment based at least in part on the DMS obtaining a second snapshot of the second directory during the second time period.

15. The method of claim 1, further comprising:
updating, by the DMS, a snapshot of the non-relational database based at least in part on data of the operation log, wherein the DMS initiated a capture of the snapshot prior to a time at which the one or more modified documents were modified.

16. An apparatus, comprising:
one or more memories storing processor-executable code; and
one or more processors coupled with the one or more memories and individually or collectively operable to execute the code to cause the apparatus to:
read, by an agent of a data management system (DMS) at a host of a non-relational database, data of an operation log into a first queue within working memory of the host, wherein the data of the operation log is indicative of one or more modified documents in a first collection of the non-relational database, and wherein the first queue is associated with a plurality of collections of the non-relational database, the plurality of collections comprising the first collection;
move, by the agent, the data of the operation log from the first queue to a second queue within the working memory of the host based at least in part on the operation log being indicative of the one or more modified documents in the first collection and based at least in part on the second queue being associated with the first collection;
write, by the agent, the data of the operation log from the second queue to a first location within a local disk memory of the host; and
move, by the agent, the data of the operation log from the first location within the local disk memory to a remote storage environment accessible to the DMS.

17. The apparatus of claim 16, wherein the one or more processors are individually or collectively further operable to execute the code to cause the apparatus to:
determine, by the agent, a generation of the operation log for addition to an operation log collection of the non-relational database, wherein the one or more processors are individually or collectively operable to execute the code to cause the apparatus to read the data of the operation log into the first queue based at least in part on determining the generation of the operation log.

18. The apparatus of claim 17, wherein the one or more processors are individually or collectively operable to execute the code to cause the apparatus to read the data of the operation log into the first queue prior to the addition of the operation log to the operation log collection.

19. The apparatus of claim 16, wherein the one or more processors are individually or collectively further operable to execute the code to cause the apparatus to:
determine, based at least in part on reading the data of the operation log into the first queue, that the operation log is associated with the first collection.

20. A non-transitory computer-readable medium storing code, the code comprising instructions executable by one or more processors to:
read, by an agent of a data management system (DMS) at a host of a non-relational database, data of an operation log into a first queue within working memory of the host, wherein the data of the operation log is indicative of one or more modified documents in a first collection of the non-relational database, and wherein the first queue is associated with a plurality of collections of the non-relational database, the plurality of collections comprising the first collection;
move, by the agent, the data of the operation log from the first queue to a second queue within the working memory of the host based at least in part on the operation log being indicative of the one or more modified documents in the first collection and based at least in part on the second queue being associated with the first collection;
write, by the agent, the data of the operation log from the second queue to a first location within a local disk memory of the host; and
move, by the agent, the data of the operation log from the first location within the local disk memory to a remote storage environment accessible to the DMS.
